(19) United States
(12) Patent Application Publication
(10) Pub. No.: US 2011/0148097 A1
(43) Pub. Date: Jun. 23, 2011

(54) Specifically Compatible Connectors for Administration of Stored Gases

(76) Inventor: Jeffrey H. Ping, Braselton, GA (US)

(21) Appl. No.: 11/570,823

(22) PCT Filed: Jun. 17, 2005
(86) PCT No.: PCT/US2005/021555

§ 371 Date: Nov. 27, 2007

Related U.S. Application Data
(60) Provisional application No. 60/581,321, filed on Jun. 18, 2004.

(51) Int. Cl. F16L 39/00

(52) U.S. Cl. 285/125.1; 285/23; 285/131.1; 285/140.1; 285/311; 285/320

(57) ABSTRACT

This invention relates to the field of connectors used to connect gas sources to apparatus for the administration or other use of gas or mixtures of gases, and more specifically to connectors used for gas administration for respiratory support of a user or patient. The connectors according to the present invention are shaped to be specifically compatible only with like connectors for each specific type gas or gas mixture used in the application, thus reducing or eliminating the chance for user error in connecting the wrong distribution connector to a particular supply connector.

### TECHNICAL FIELD OF THE INVENTION

The present invention relates generally to the field of couplings, related in-line devices, and delivery conduits for gases used in respiratory support applications, and relates more specifically to the administration of mixtures of two or more gases for medically therapeutic or other respiratory support applications or environmentally controlled systems in which proper connection to a specific gas source is critical for safe and proper gas use.

### BACKGROUND OF THE INVENTION

In industrial, healthcare, aerospace, and recreational underwater settings, a gas or mixture of gases is often contained within pressurized cylinders, tanks, or other containers, from which a controlled release of the gas is effected for a desired purpose. In many such applications, compressed air, pure oxygen, or a mixture of oxygen and other gases is often contained within pressurized cylinders, tanks, or other vessels and dispensed for use in breathing by persons in low oxygen environments, or by persons with impaired respiratory function. In certain industrial and research settings, it is desirable to provide a controlled atmosphere with a specific ambient gas or gas mixture contained, and common gas sources must be connected to an environmental chamber to deliver the desired atmospheric content.

In existing settings involving the administration of stored gases or gas mixtures, the standard end fittings for conventional gas delivery lines consist of identical ridged tubing bibs, so that different gases may too easily be connected to the wrong delivery systems.

Administration of another gas instead of specifically oxygen or air may produce a situation incompatible with life, or result in an improper gas admixture with adverse physiologic or environmental sequelae.

Existing technology for pressurized gas cylinders, tanks, and other containers does not provide for unique couplings to ensure proper connection of a gas delivery system to the appropriate gas source.

Applications that involve the administration of a gas for respiratory support often involve settings with gas sources supplied through multiple available distribution channels which may include oxygen, compressed air, nitrogen, helium, nitrous oxide, carbon dioxide, combinations thereof, and other single or mixed gas sources.

In an application where a person is relying upon a pressurized gas container to provide oxygen for respiratory assistance or support, there is the potential risk that a connection might be inadvertently made to the wrong gas source, resulting in the administration of an undesired gas or gas mixture to a user or patient. Such a situation could have catastrophic results, and could result in serious injury or death.

In an industrial or research setting dependent upon a controlled specific atmosphere, incorrect connections to a multi-channel gas distribution system or multiple gas tanks may result in adverse results which may range from the spoiling of manufacturing processes or research studies to potentially hazardous conditions.

Thus, the need exists for pressurized gas cylinders, tanks, and other containers used for biological respiratory support and other environmental control systems that incorporate unique couplings to ensure proper connection of a gas delivery system to the appropriate gas source.

### SUMMARY OF THE INVENTION

It is an object according to the present invention to provide gas delivery systems with specifically compatible connectors to prevent inadvertent connection of delivery devices to incorrect gas sources.

It is a further object according to the present invention to provide gas delivery systems with connector systems that allow quick and accurate connections of gas delivery apparatus to gas sources with diminished opportunities for user error.

These and other features, aspects, and other advantages according to the present invention will become more apparent and more readily understood with regard to the following specification, drawings, description, appended claims, and any examples of the present preferred embodiments of the invention which are disclosed herein.

### BRIEF DESCRIPTION OF THE DRAWINGS

FIG. 1 provides a drawing of a conventional gas connector system with identical gas supply connectors for each of two gas supply channels.

FIG. 2 provides a drawing of an exemplary gas connector system with specifically compatible connectors for each of two gas supply channels according to the present invention.

FIG. 3 provides a drawing of an exemplary gas connector system with specifically compatible male and female connectors for a gas supply channel according to the present invention.

FIG. 4 provides a drawing of an exemplary gas connector system with specifically compatible barbed connectors for an exemplary dual gas supply system according to the present invention.

FIG. 5 provides a drawing of an exemplary gas connector system with specifically compatible barbed connectors for an alternate arrangement of an exemplary dual gas supply system according to the present invention.

FIG. 6 provides a drawing of an exemplary gas connector system with specifically compatible barbed connectors for another alternate arrangement of an exemplary dual gas supply system according to the present invention.

### DETAILED DESCRIPTION OF THE INVENTION

The present invention may be understood more readily by reference to the following detailed description of the preferred embodiments of the invention and the Examples included herein. However, before the preferred embodiments of the devices and methods according to the present invention are disclosed and described, it is to be understood that this invention is not limited to the exemplary embodiments described within this disclosure, and the numerous modifications and variations therein that will be apparent to those skilled in the art remain within the scope of the invention disclosed herein. It is also to be understood that the terminology used herein is for the purpose of describing specific embodiments only and is not intended to be limiting.

Unless otherwise noted, the terms used herein are to be understood according to conventional usage by those of ordinary skill in the relevant art. In addition to the definitions of terms provided below, it is to be understood that as used in the specification and in the claims, “a” or “an” can mean one or more, depending upon the context in which it is used.

The term “gas container” as used herein is defined as any cylinder, tank, or other vessel used to confine and contain a gas for controlled release and use thereof. Preferably, a gas container is capable of storing gas under high pressure.

The term “connector” as used herein is defined as any gas valve, regulator, tubing or other flow-through attachment fitting used to provide gas flow continuity for the delivery of a gas from a container.

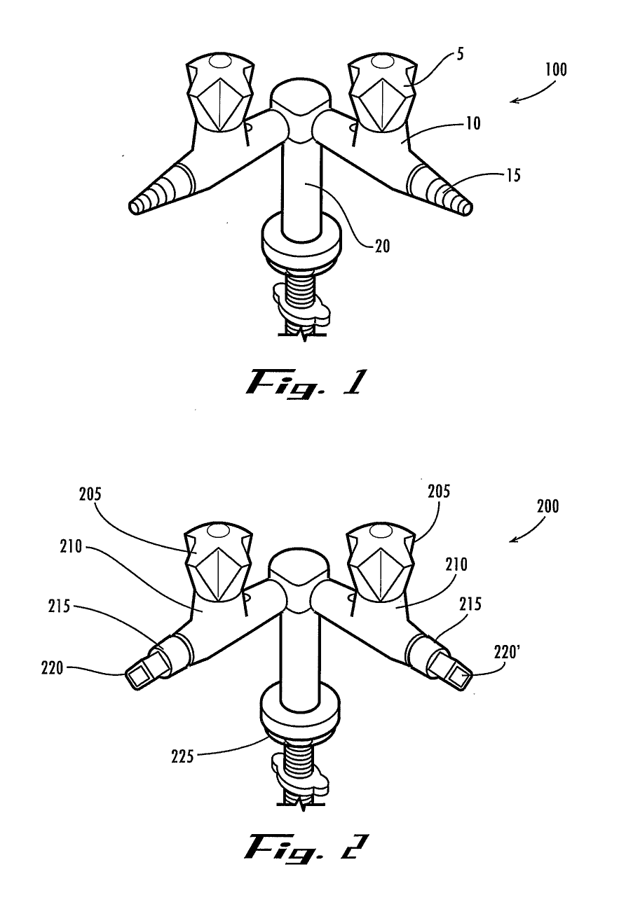

Referring now to an exemplary conventional gas supply connector as shown in FIG. 1, a gas supply connector component 100 attaches in flow continuity with a gas supply 20 which may represent a gas tank, cylinder, reservoir, piping or tubing in flow continuity with such a gas source, and is provided with a gas supply valve 10 operable by a gas valve control 5 and terminating in a gas supply connector 15. It is noted that the gas supply connector 5 as shown is a standard, tapering gas hose bib with a series of ridges of tapering diameters to allow slip-on attachment and frictional retention of a rubber, plastic, or other polymeric tubing or connector. The illustration of FIG. 1 shows a dual head supply. In various applications, both heads could be connected to the same gas supply. In other applications commonly employed, each head could be connected to a different gas supply. In that event, the different gases would be accessible through identical gas supply connectors, opening the risks of erroneous connections and undesirable results.

FIG. 2 shows an exemplary embodiment according to the present invention, in which a dual headed gas supply connector 200 attaches in flow continuity with a common gas supply 225 which may represent one or more gas tanks, cylinders, reservoirs, or piping or tubing in flow continuity with such a gas source or sources. As shown in FIG. 2, each head is provided with a gas supply valve 210 operable by a gas valve control 205 and terminating in a gas supply connector 220 and 220′. Near the terminal ends of the gas supply connectors 220 and 220′ is a retention mechanism 215 which may be employed in various embodiments according to the present invention to secure a connection. In various possible embodiments of the present invention, the retention mechanism 215 may represent a tapered hose bib, screw-thread receptor, a locking ring, or any other latching mechanism that could serve to secure a connection at the gas supply connectors 220 and 220′.

It should be noted that the gas supply connectors 220 and 220′ such as shown in FIG. 2 are of different shapes, with gas supply connector 220 ending in a square or diamond-shaped tube, and gas supply connectors 220′ ending in a round tube. In this example, gas supply connector 220 may be either a male or female connector, and would be able to securely attach only to a similarly-shaped square/diamond tubular connector of opposite gender. Similarly, gas supply connector 220′ may be either a male or female connector, and would be able to securely attach only to a similarly-shaped round tubular connector of opposite gender. Thus, the same connector would not be capable of secure attachment to both gas supply connectors 220 and 220′.

The present invention provides that uniquely compatible shaped connectors are also employed on single headed gas connectors and the respective tubing or operable devices associated therewith. Therefore, the uniquely compatible shaped connectors are employed on the connectors adjacent gas containers, as well as the connectors adjacent the device intended for administration of the gas, such as a nebulizer or respirator mask, and on the tubing therebetween.

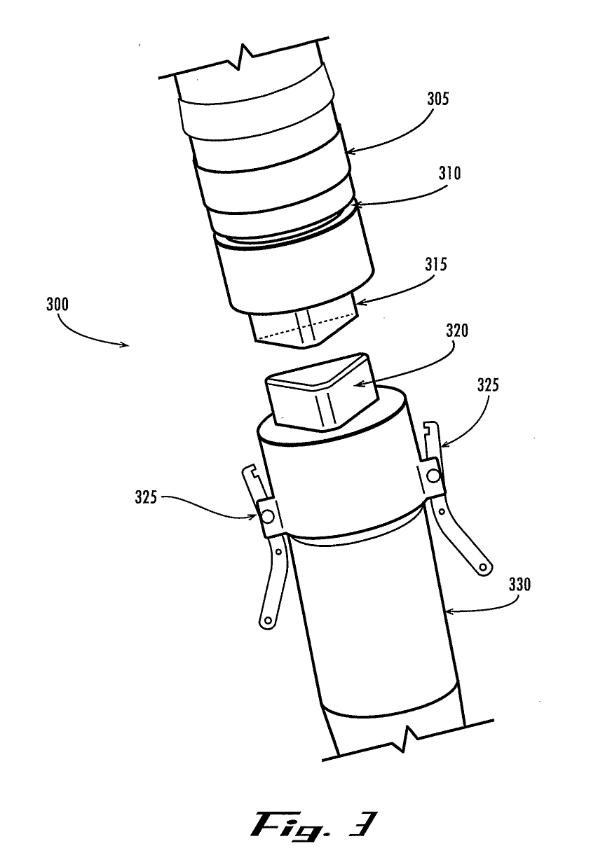

FIG. 3 shows an exemplary embodiment of another set of connectors according to the present invention. Here, the connectors 300 comprise mating ends of two tubings, a distribution tubing 305 and a supply tubing 330. A set of pivoting locking jaws 325 near the end of one tubing is provided to engage a locking ring 310 near the end of the other tubing. In the example shown, a male connector 320 is provided as a triangularly-shaped tube, and is sized to be received by a female connector 315 on the other tubing. In various embodiments according to the present invention, the locations and mechanical nature of the locking mechanism, the terminal shape of the connectors, and the gender of the supply and distribution sides of a connection may be changed to include any possible arrangement thereof. The locking mechanism may involve a mechanical jaw/rim lock as show, or may involve a threaded screw, friction detent, or other conventional locking system.

In specific applications according to the present invention, it is provided that differing shaped connectors of appropriate gender would be consistently used for specific gas sources, so that inadvertent improper connections would not be possible. In such various embodiments, the uniquely compatible mating connectors can each be round, oval, triangular, square, rectangular, hourglass-shaped, octagonal, polygonal, or other geometric or non-geometric shape, and of varying sizes to allow sufficient specific keying of the gas distribution system involved.

### EXAMPLE 1

A specific example of an embodiment according to the present invention is in the field of respiratory therapy, and relates to the therapeutic administration of helium and oxygen (heliox) in gas mixtures of specific concentrations. Medical uses of heliox are expanding, and clinical improvements have been reported in a number of chronic respiratory disorders. Heliox therapy inherently depends upon the mixture of two gas sources. While single containers may be obtained with a specified gas concentration, it would be useful if hospitals could make use of their standard, piped-in oxygen distribution systems to feed a gas mixer with a separate helium source to be able to customize the heliox ratio for a given patient and clinical situation. Using conventional technology, it would be dangerously easy to confuse the gas supplies due to their common connectors, and the result of such an error could be catastrophic. Using specifically compatible connectors according to the present invention, a helium distribution line could only be connected to a helium supply line with for example triangular shaped male-female compatible connectors, and an oxygen distribution line could only be connected to an oxygen supply line with for example square shaped male-female compatible connectors, effectively eliminating the chance of improper source connections.

### EXAMPLE 2

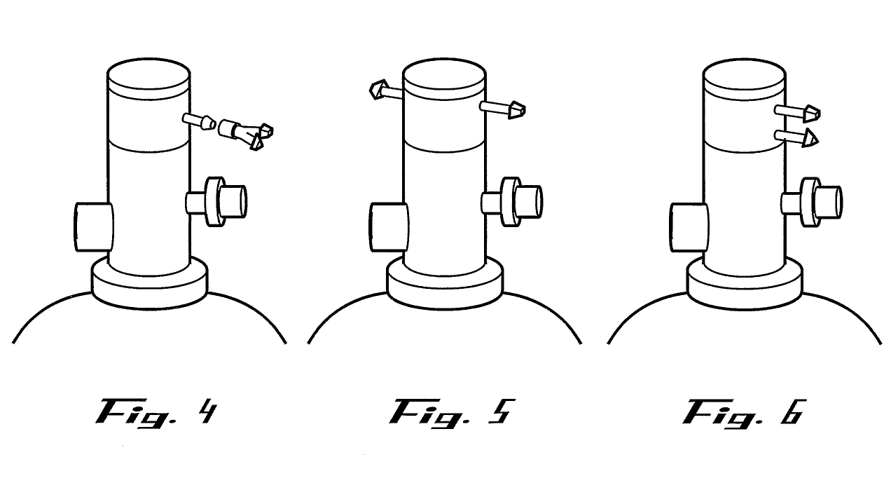

Another specific example of an embodiment according to the present invention in the field of respiratory therapy relates to the therapeutic administration of helium and oxygen (heliox) in gas pre-mixtures of specific concentrations. Using specifically compatible connectors according to the present invention, a helium/oxygen supply container distribution line can only be connected to a helium/oxygen supply line and nebulizer mask with (for example) octagonal shaped male-female compatible connectors, effectively eliminating the chance of improper source connections. In another exemplary embodiment according to the present invention, specific connection geometry would be provided to distinguish the nebulizer and reservoir so that helium/oxygen could be supplied without use of a nebulizer and without the possibility of confusion that could result in no gas supply. Further examples of specifically compatible connectors according to the present invention are shown in FIGS. 4-6 where the connectors are shown in association with a dual gas supply container and regulator, such as those employed for heliox applications.

Finally, while there have been shown and described and pointed out fundamental novel features of the present invention as applied to preferred embodiments thereof, it will be understood that various omissions and substitutions and changes in the materials, form, and details of the devices and processes illustrated, and in their operation, and in the method illustrated and described, may be made by those skilled in the art without departing from the spirit of the invention as broadly disclosed herein. All of the above-discussed patents and publications are hereby expressly incorporated by reference as if they were written directly herein.

We claim:

1. A system of connectors for use in gas distribution systems, wherein said connectors are shaped to be specifically compatible only with like connectors for a specific gas supply in use in a given application.

2. The system of claim 1, wherein said connectors are provided as male and/or female mating connectors with similarly shaped and sized cross-sectional dimensions.

3. The system of claim 1, wherein said connectors are provided as hose bibs.

4. The system of claim 3, wherein said hose bibs are provided as tapered male hose bibs to receive mating female tubing or other mating female connectors.

5. The system of claim 2, wherein said male connectors are provided in their cross-sectional dimension as substantially round, and sized to allow specific keying with like-shaped female connectors specific to a desired gas distribution system.

6. The system of claim 2, wherein said male connectors are provided in their cross-sectional dimension as substantially oval, and sized to allow specific keying with like-shaped female connectors specific to a desired gas distribution system.

7. The system of claim 2, wherein said male connectors are provided in their cross-sectional dimension as substantially triangular, and sized to allow specific keying with like-shaped female connectors specific to a desired gas distribution system.

8. The system of claim 2, wherein said male connectors are provided in their cross-sectional dimension as substantially square, and sized to allow specific keying with like-shaped female connectors specific to a desired gas distribution system.

9. The system of claim 2, wherein said male connectors are provided in their cross-sectional dimension as substantially rectangular, and sized to allow specific keying with like-shaped female connectors specific to a desired gas distribution system.

10. The system of claim 2, wherein said male connectors are provided in their cross-sectional dimension as substantially hourglass-shaped, and sized to allow specific keying with like-shaped female connectors specific to a desired gas distribution system.

11. The system of claim 2, wherein said male connectors are provided in their cross-sectional dimension as substantially octagonal, and sized to allow specific keying with like-shaped female connectors specific to a desired gas distribution system.

12. The system of claim 2, wherein said male connectors are provided in their cross-sectional dimension as substantially polygonal, and sized to allow specific keying with like-shaped female connectors specific to a desired gas distribution system.

13. The system of claim 2, wherein said male connectors are provided in their cross-sectional dimension as substantially of any geometric or non-geometric shape, and sized to allow specific keying with like-shaped female connectors specific to a desired gas distribution system.

14. The system of claim 1, wherein said connectors further comprise a retention mechanism to discourage or prevent undesired separation of said connectors in use.

15. The system of claim 14, wherein said retention mechanism comprises screw-thread receptors and connectors.

16. The system of claim 14, wherein said retention mechanism comprises a friction detent system.

17. The system of claim 14, wherein said retention mechanism comprises a mechanical jaw/rim lock system.

18. A method of delivering one or more specific, desired gases, comprising use of a system of gas connectors that are shaped to be specifically compatible only with like connectors for each specific gas supply in use in a given application.
